(19) United States
(12) Patent Application Publication
(10) Pub. No.: US 2021/0312541 A1
(43) Pub. Date: Oct. 7, 2021

(54) COMPUTER SYSTEMS AND METHODS FOR GENERATING VALUATION DATA OF A PRIVATE COMPANY

(71) Applicant: Valsys Inc., Toronto (CA)

(72) Inventor: James Worthington, London (GB)

(21) Appl. No.: 17/296,135

(22) PCT Filed: Nov. 25, 2019
(86) PCT No.: PCT/CA2019/051680

§ 371 Date: May 21, 2021

Related U.S. Application Data
(60) Provisional application No. 62/771,433, filed on Nov. 26, 2018.

(51) Int. Cl. G06Q 40/00; G06N 20/00; G06K 9/62

(52) U.S. Cl. CPC G06Q 40/00; G06K 9/6242; G06K 9/6256; G06N 20/00

(57) ABSTRACT

A system for generating valuation data of a private company. The system includes a data merger, a model trainer, a user input receiver, and a model predictor. The data merger is for receiving company data. At least one company metric of the plurality of company metrics corresponds to a company other than the private company. The model trainer is for generating a machine learning model, based on the company data. The machine learning model includes a plurality of variables. Each variable of the plurality of variables corresponds to at least one company metric of the plurality of company metrics. The user input receiver is for receiving a request to generate the valuation data. The model predictor is for generating the valuation data based on the machine learning model and the request to generate the valuation data.

### TECHNICAL FIELD

The embodiments disclosed herein relate to computer systems that generating valuation data of a private company and, in particular to computer systems and methods for generating valuation data of a private company based on a machine learning model.

### INTRODUCTION

Private company valuation is a process often undertaken by investment banking and private equity professionals. Mergers & Acquisitions teams within investment banks value private companies (“targets”) that their clients are either selling or buying. Private equity firms value companies that they are looking to acquire as well as continuously value their portfolio companies to give their investors a sense of the fund's performance.

Unlike public companies, private companies do not have a publicly quoted share price and number of shares which update in real time. Thus, some valuation metrics of private companies, such as Market Capitalization (Current Share Price×Total Number of Shares) and Enterprise Value (Market Capitalization+Debt−Cash), cannot be directly calculated by a party external to the organization.

Processes for valuing private companies fall into two main categories: intrinsic valuation and market pricing. Intrinsic valuation involves projecting the company's future earnings and calculating the current value of these earnings. Market pricing involves analyzing the prices at which similar companies are bought and sold in the current market.

For a market pricing valuation, practitioners look for comparable companies to the target that are either publicly traded or private companies that have recently been sold. This means they have financial and valuation metrics for these comparable companies (“comparables”). However, there are a number of inherent difficulties with this process. It can be difficult to decide on what constitutes the best set of comparables. For example, it can be difficult to compare companies of different size, in different industries or geography, or with different business models. Moreover, the set of comparables is often too small (commonly 5-10) to draw statistically robust conclusions. Comparable private company data is often sparse or incorrect. However, public company data, while more readily available and accurate, is typically less similar to private company data, and therefore more difficult to compare. It can also be difficult to decide on which financial and valuation metrics to rely on, since relationships between metrics are unclear. Because no comparable is exactly similar to the target company, analysts must subjectively account for how these differences could affect their analysis. Given the subjective decisions inherent in the process, it may not be possible to create a valuation for a private company which updates in real time. This means that external parties trying to estimate the value of a private company may be at a significant disadvantage to those trying to value a public company for which real time share price data is available.

Accordingly, there is a need for improved systems and methods for generating valuation data of a private company.

### SUMMARY

Provided is a system for generating valuation data of a private company which may update in real time. The system includes a data merger, the data merger for receiving company data, the company data including a plurality of company metrics, wherein at least one company metric of the plurality of company metrics corresponds to a company other than the private company; a model trainer, the model trainer for generating a machine learning model, based on the company data, the machine learning model including a plurality of variables, each variable of the plurality of variables corresponding to at least one company metric of the plurality of company metrics; a user input receiver, the user input receiver for receiving a request to generate the valuation data; and a model predictor, the model predictor for generating the valuation data based on the machine learning model and the request to generate the valuation data.

The request to generate the valuation data may include private company data. The private company data may include at least one financial metric of the private company. The at least one financial metric of the private company may correspond to the at least one variable of the plurality of variables.

The system may further include a data pre-processor, the data preprocessor for normalizing the company data, based on at least one statistical property of at least one company metric of the plurality of company metrics.

The system may further include a data pre-processor, the data pre-processor for: determining whether the company data includes missing data; and generating replacement data, whereby the replacement data replaces the missing data.

The system may further include a data splitter, the data splitter for apportioning the company data into training data, calibration data, and testing data; a confidence calibrator, the confidence calibrator for generating a confidence score for at least one company metric of the plurality of company metrics, based on the machine learning model and the calibration data.

The system may further include a model tester, the model tester for generating model testing data based on the machine learning model and the testing data.

Provided is a computer-implemented method for generating valuation data of a private company. The method includes receiving company data, the company data including a plurality of company metrics, wherein at least one company metric of the plurality of company metrics corresponds to a company other than the private company; generating a machine learning model, based on the company data, the machine learning model including a plurality of variables, each variable of the plurality of variables corresponding to at least one company metric of the plurality of company metrics; receiving a request to generate the valuation data; and generating the valuation data, based on the machine learning model and the request to generate the valuation data.

The valuation data may include variable importances that quantify the impact of the at least one company metric on valuation prediction, and wherein the variable importances correspond to a relative effect of the at least one company metric.

The request to generate the valuation data may include private company data, the private company data including at least one financial metric of the private company, the at least one financial metric of the private company corresponding to the at least one variable of the plurality of variables.

The machine learning model may include optimizing a loss function.

Generating the machine learning model may include multi-target learning.

The method may further include normalizing the company data, based on at least one statistical property of at least one company metric of the plurality of company metrics.

The method may further include determining whether the company data includes missing data; and generating replacement data, whereby the replacement data replaces the missing data.

Generating replacement data may be based on at least one statistical property of at least one company metric of the plurality of company metrics.

Generating replacement data may be based on the machine learning model.

The method may further include apportioning the company data into training data, calibration data, and testing data; and generating a confidence score for at least one company metric of the plurality of company metrics, based on the machine learning model and the calibration data.

The method may further include generating model testing data based on the machine learning model and the testing data.

The method may further include generating a further machine learning model, based on the model testing data, and the machine learning model.

The valuation data may include comparable company data and company metric importance data.

Provided is a non-transitory computer-readable medium storing instructions executable on a processor for implementing a method for generating valuation data of a private company. The method include receiving company data, the company data including a plurality of company metrics, wherein at least one company metric of the plurality of company metrics corresponds to a company other than the private company; generating a machine learning model, based on the company data, the machine learning model including a plurality of variables, each variable of the plurality of variables corresponding to at least one company metric of the plurality of company metrics; receiving a request to generate the valuation data; and generating the valuation data, based on the machine learning model and the request to generate the valuation data.

### BRIEF DESCRIPTION OF THE DRAWINGS

The drawings included herewith are for illustrating various examples of articles, methods, and apparatuses of the present specification. In the drawings:

FIG. 1 is a block diagram of a system of computer devices connected to a network, in accordance with an embodiment;

FIG. 2 is a block diagram of a computer device shown in FIG. 1, in accordance with an embodiment;

FIG. 3 is a diagram of company data;

FIG. 4 is a graph of company data;

FIG. 5 is a graph of company data;

FIG. 6 is a flowchart of a method for generating valuation data of a private company, in accordance with an embodiment;

FIG. 7 is a block diagram of a computer system for generating valuation data of a private company, in accordance with an embodiment;

FIG. 8 is a diagram of company data having a plurality of company metrics, in accordance with an embodiment;

FIG. 9 is a graph created from the method of FIG. 6;

FIG. 10 is a flowchart of a method for generating valuation data of a private company, in accordance with an embodiment;

FIG. 11 is a diagram of private company data, in accordance with an embodiment; and

FIG. 12 is a user interface displaying valuation data, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

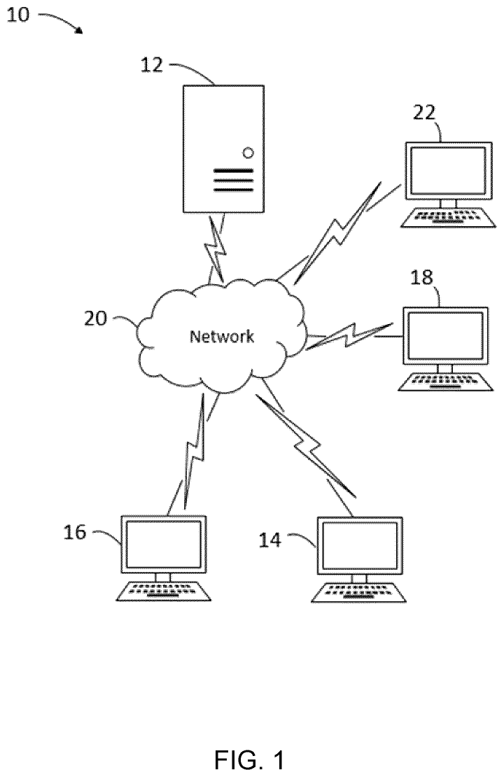

Referring now to FIG. 1, shown therein is a block diagram illustrating a system 10, in accordance with an embodiment. The system 10 includes a server platform 12 which communicates with a plurality of third-party devices 14, a plurality of developer devices 16, and a plurality of administrator devices 18 via a network 20. The server platform 12 also communicates with a plurality of user devices 22. The server platform 12 may be a purpose built machine designed specifically for generating valuation data of a private company.

The server platform 12, third-party devices 14, developer devices 16, administrator devices 18 and user devices 22 may be a server computer, desktop computer, notebook computer, tablet, PDA, smartphone, or another computing device. The devices 12, 14, 16, 18, 22 may include a connection with the network 20 such as a wired or wireless connection to the Internet. In some cases, the network 20 may include other types of computer or telecommunication networks. The devices 12, 14, 16, 18, 22 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20. Input device may include any device for entering information into device 12, 14, 16, 18, 22. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18, 22 may include multiple of any one or more of processors, applications, software modules, second storage devices, network connections, input devices, output devices, and display devices.

Although devices 12, 14, 16, 18, 22 are described with various components, one skilled in the art will appreciate that the devices 12, 14, 16, 18, 22 may in some cases contain fewer, additional or different components. In addition, although aspects of an implementation of the devices 12, 14, 16, 18, 22 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18, 22 and/or processor to perform a particular method.

In the description that follows, devices such as server platform 12, third-party devices 14, developer devices 16, administrator devices 18, and user devices 22 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16, 18, 22 may send information to the server platform 12. For example, a third-party user using the third-party device 14 may manipulate one or more input devices (e.g. a mouse and a keyboard) to interact with a user interface displayed on a display of the third-party device 14. Generally, the device may receive a user interface from the network 20 (e.g. in the form of a webpage). Alternatively or in addition, a user interface may be stored locally at a device (e.g. a cache of a webpage or a mobile application).

Server platform 12 may be configured to receive a plurality of information, from each of the plurality of third-party devices 14, developer devices 16, administrator devices 18, and user devices 22. Generally, the information may comprise at least an identifier identifying the third-party, developer, administrator, or user. For example, the information may comprise one or more of a username, e-mail address, password, or social media handle.

In response to receiving information, the server platform 12 may store the information in storage database. The storage may correspond with secondary storage of the device 12, 14, 16, 18, 22. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The third-party device 14 may be associated with a third-party account. Similarly, the developer device 16 may be associated with a developer account, the administrator device 18 may be associated with an administrator account, and the user device 22 may be associated with a user account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

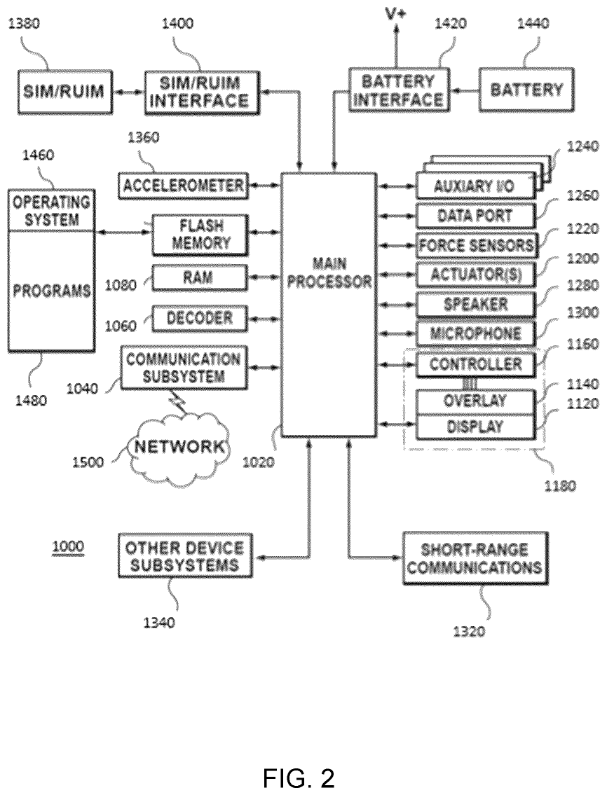

Referring now to FIG. 2, shown therein is a simplified block diagram of components of a mobile device or portable electronic device 1000, in accordance with an embodiment. The portable electronic device 1000 may be any of the devices 12, 14, 16, 18, 22 of FIG. 1. The portable electronic device 1000 includes multiple components such as a processor 1020 that controls the operations of the portable electronic device 1000. Communication functions, including data communications, voice communications, or both may be performed through a communication subsystem 1040. Data received by the portable electronic device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The portable electronic device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360 as shown in FIG. 2. The accelerometer 1360 may be utilized for detecting direction of gravitational forces or gravity-induced reaction forces.

To identify a subscriber for network access according to the present embodiment, the portable electronic device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The portable electronic device 1000 also includes an operating system 1460 and software components 1480 that are executed by the processor 1020 and which may be stored in a persistent data storage device such as the flash memory 1100. Additional applications may be loaded onto the portable electronic device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

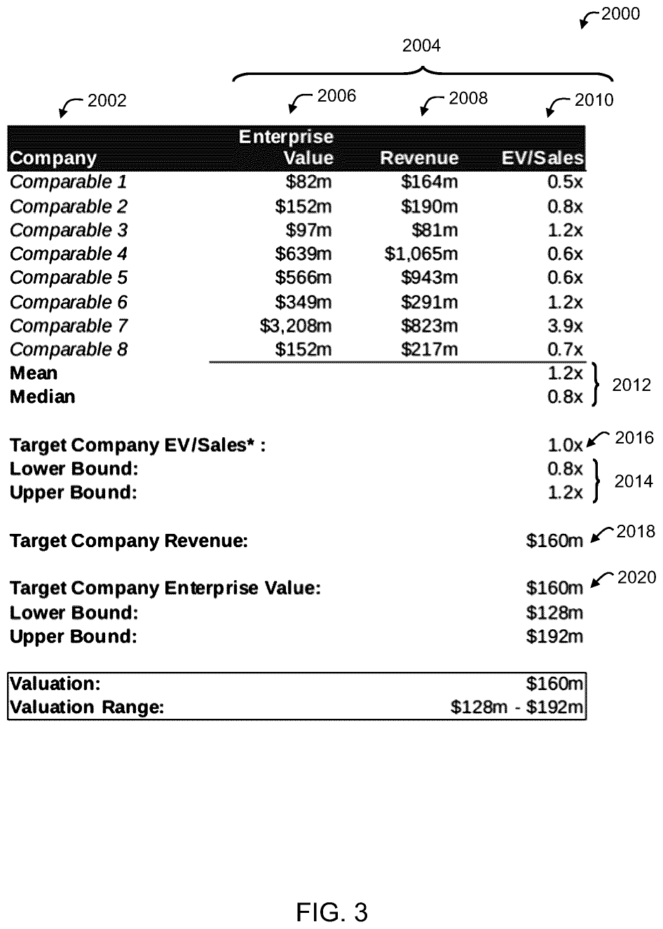

Referring now to FIG. 3, shown therein is a diagram of company data 2000. Company data 2000 are inputs and outputs for a conventional method for generating valuation data of a private company. The conventional method generally relates to analysis of company metrics of comparable companies.

Comparable companies (or comparables) generally refer to recently sold companies that are similar to the target private company. For example, the comparables may be in the same geography or industry as the target company. Similarly, the comparables may have a similar business model to the target company. In company data 2000, comparables 2002 include Comparables 1-8.

Company metrics include metrics that may be related to the valuation of a company, such as financial metrics or valuation metrics. In company data 2000, company metrics 2004 include Enterprise Value 2006 and Revenue 2008. Company metrics further include metrics that combine two or more other company metrics, such as a ratio of two company metrics. In company data 2000, company metrics 2004 include EV/Sales 2010 (Enterprise to Sales Value; i.e., Enterprise Value/Revenue). Ratios or other combination metrics allow companies of different sizes to be more easily compared. That is, both large and small companies may be included within the same set of comparables.

The mean or median value of a company metric for a set of comparables may be used to predict a company metric of the target company. The mean may be a weighted average based on the similarity of the comparables. The average of the mean and median value may also be used to estimate a company metric of the target. In company data 2000, the average of mean and median 2012 of EV/Sales 2010 is used to determine Target Company EV/Sales 2016.

The mean and median of a company metric may be different. The mean and median of a company metric for a set of comparables may be used to provide a range for a predicted company metric. In company data 2000, mean and median 2012 provide upper and lower bounds 2014.

Predicted or estimated company metrics for a target company may be further used to estimate or predict other company metrics of the target company. The predicted company metrics may be used in combination with actual or real company metrics or other predicted or estimated company metrics. In company data 2000, the Target Company Revenue 2018 is used to determine the Target Company Enterprise Value 2020, based on the Target Company EV/Sales 2016. Specifically, the Target Company EV/Sales 2016 is multiplied by the Target Company Revenue 2018 to obtain the Target Company Enterprise Value 2020.

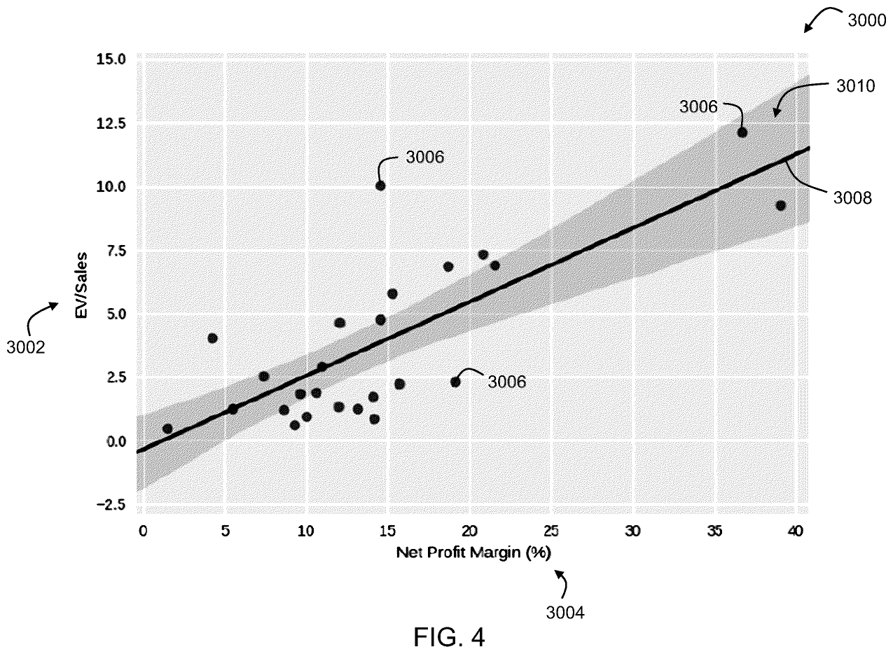

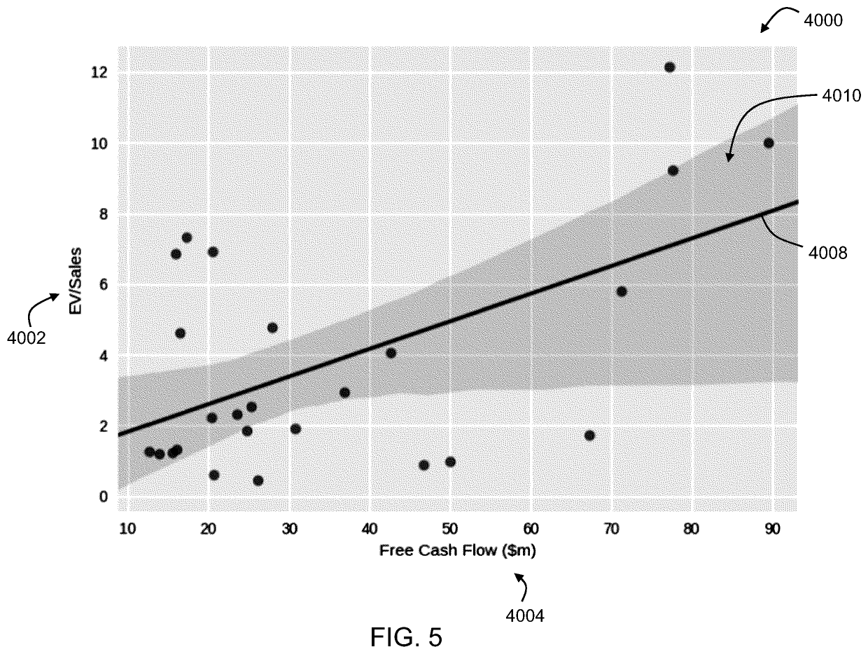

Referring now to FIGS. 4 and 5, shown therein are graphs 3000, 4000 of company data. Graphs 3000, 4000 are outputs for another conventional method for generating valuation data of a private company. The conventional method also generally relates to analysis of company metrics of comparable companies.

A group of comparables may be analyzed with respect to two company metrics. Scatterplot graphs may be used to visualize the relationship between the two company metrics. That is, a first company metric may be plotted against a second company metric for a set of comparables. In graph 3000, EV/Sales 3002 is plotted against Net Profit Margin 3004. Similarly, in graph 4000, EV/Sales 4002 is plotted against Free Cash Flow 4004. Thus, each comparable is represented on the scatterplot graph as a single data point. In graph 3000, each data point of a plurality of data points 3006 corresponds to a single comparable in a set of comparables. The same can be said of data points in graph 4000. The relative position of each comparable on the scatterplot graph depends on the company metrics of the comparable.

The relationship between two company metrics for a set of comparables may be estimated by applying a linear regression. That is, a linear approach may be used to model the relationship between the two company metrics of a group of comparables. The relationship may be visualized on the scatter plot graph as a line of best fit. Graph 3000 includes line of best fit 3008 and graph 4000 includes line of best fit 4008. Line of best fit 3008 is a trend line that represents the relationship between EV/Sales 3002 and Net Profit Margin 3004. Line of best fit 4008 is a trend line that represents the relationship between EV/Sales 4002 and Free Cash Flow 4004.

If either of the two company metrics of the target company is known, the other company metric can be estimated, based on the linear regression. For example, based on line of best fit 3008 of graph 3000, if the Net Profit Margin of a target company was known to be 35%, the EV/Sales of the target company could be predicted to be approximately 10.0.

Linear regression analysis may also be used to calculate a confidence region. The confidence region quantifies a range of uncertainty or error for the linear regression model. The size of the confidence region generally relates to the accuracy of the predicted relationship between the two company metrics. The confidence region can vary depending on the company metrics and comparables selected. Graphs 3000, 4000 include confidence region 3010 and confidence region 4010 respectively. Confidence region 3010 is a confidence level of line of best fit 3008. Confidence region 4010 is a confidence level of line of best fit 4008. Confidence region 3010 of graph 3000 is smaller than confidence region 4010 of graph 4000. In other words, line of best fit 3008 provides a more accurate prediction than line of best fit 4008.

It may be possible that the relationship between two company metrics is non-linear. In such situations, if linear-regression is nevertheless applied, a line of best fit may not provide accurate predictions of company metrics. In such cases, the confidence region may be large.

The conventional methods for generating valuation data of a private company illustrated in FIGS. 3, 4, and 5 have a number of inherent drawbacks. It can be difficult to decide on what constitutes the best set of comparables. For example, it can be difficult to compare companies of different size, in different industries or geography, or with different business models. Moreover, the set of comparables is often too small (commonly 5-10) to draw statistically robust conclusions. Comparable private company data is often sparse or incorrect. However, public company data, while more readily available and accurate, is typically less similar to private company data, and therefore more difficult to compare. It can also be difficult to decide on which financial and valuation metrics to rely on, since the relationships between metrics is unclear. Because no comparable is exactly similar to the target company, analysts must subjectively account for how these differences could affect their analysis. Given the subjective decisions inherent in the process, it may not be possible to create a valuation for a private company which updates in real time. This means that external parties trying to estimate the value of a private company may be at a significant disadvantage to those trying to value a public company for which real time share price data is available. Accordingly, there is a need for improved systems and methods for generating valuation data of private companies.

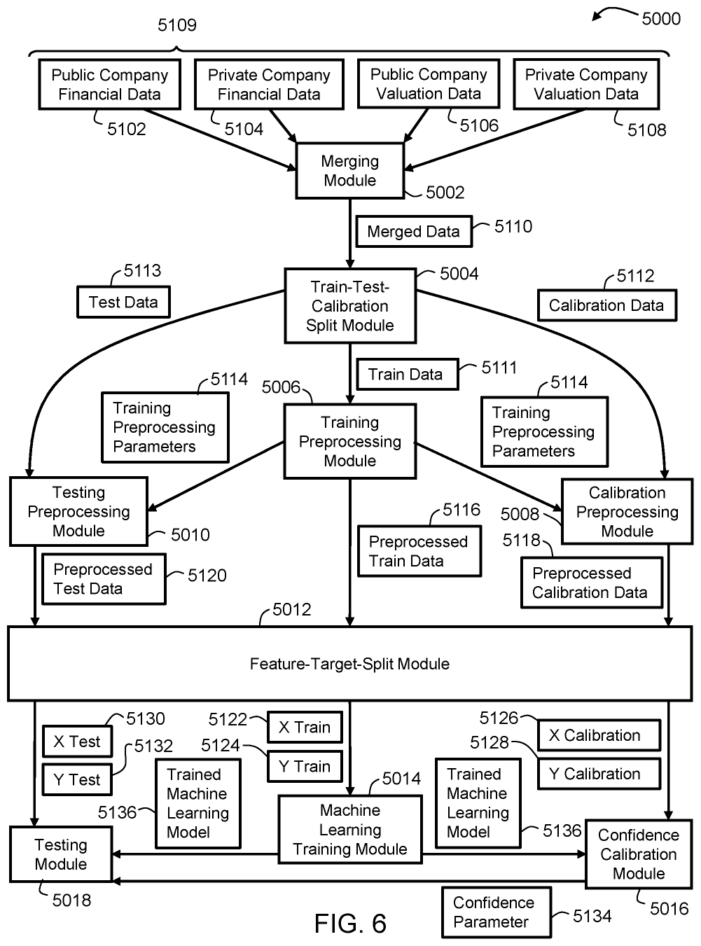

Referring now FIG. 6, shown therein is a method 5000 for generating valuation data of a private company, in accordance with an embodiment. As will become apparent, method 5000 and system addresses certain shortcomings of conventional methods. For example, method 5000 may minimize subjective decision-making, such as in the selection of comparables or company metrics. Method 5000 may also broaden the scope of analysis, for example, allowing for the use of public company data. Furthermore, method 5000 may determine relationships between company metrics, previously unknown to users.

The method 5000 may also address the time-series nature of the valuation. Conventionally, private transaction comparables are often out of date by the time the private transaction comparables are used. For example, if it is 2018 and a transaction value from 2016 is being used, the valuation does not take into account how the market has changed over those two years. In contrast, the method 5000, for example, may give less weight to older examples if the system determines that to be appropriate. This may be particularly impactful, since some industry valuations will not change considerably over time. Should public company data be included, the private company data may inherit a dynamic nature from the public company data and therefore could be updated in real time.

The method 5000 may also be faster. Since the set of comparables traditionally used is often small (as noted above), analysts attempt to comb through financial reports (where they can find them) to ensure they have as exact a figure as possible. This may be an attempt to account for the noise in the data which can be attributed to different accounting standards across firms. With the method 5000, for example, this combing through of financial reports may not be necessary, as the number and breadth of the data points used by method 5000, may smooth out any noise across the large amounts of data points (for example, tens of thousands of data points) that the method 5000 uses.

The method 5000 may provide a sense of how accurate the model is on “out of sample” data—companies the model has never seen before. This accuracy is not often practiced with the conventional methods.

The method 5000 may include variable importances and comparables generation (described below). Conventionally, it may not be possible to get an accurate sense of why a company should be priced a certain way based on market dynamics. The method 5000 provides explanation in the form of variable importances and comparable companies. Conventional methods may not provide an accurate explanation. Should the comparable companies used be public companies, these variable importances may change in real time based on public stock market dynamics.

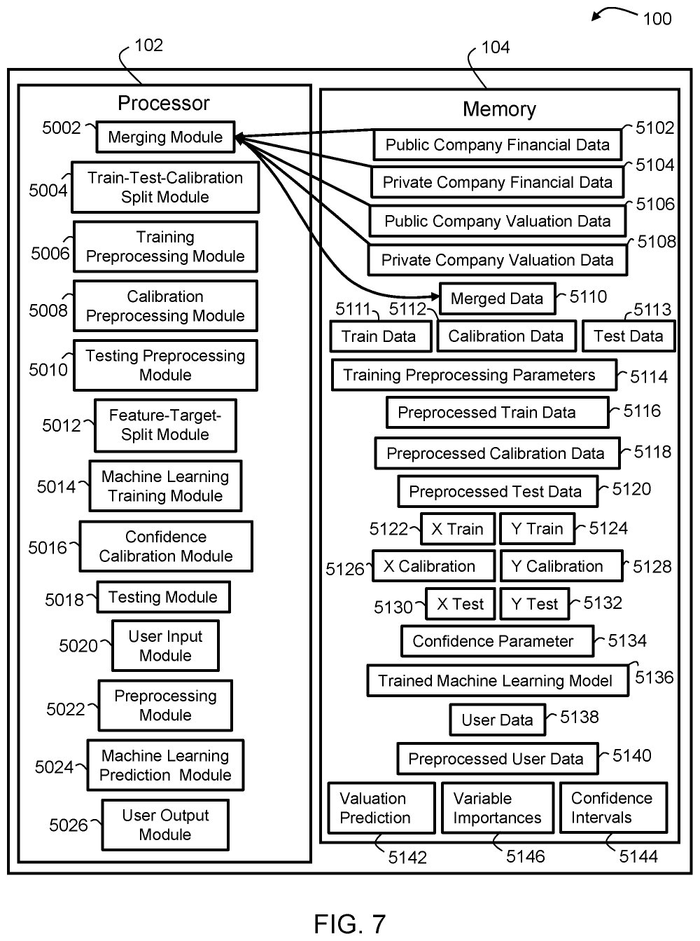

Method 5000 is implemented on a computer. Various types of computer devices and computer systems may be used to implement method 5000. For example, method 5000 may be implemented on computer devices 12, 14, 16, 18, 22 of FIG. 1, computer device 1000 of FIG. 2, or computer system 100 of FIG. 7. In some embodiments, method 5000 is implemented by one computer device. In other embodiments, method 5000 is implemented by more than one computer device. That is, various aspects of method 5000 are executed or stored in different computer devices.

Referring now to FIG. 7, where shown therein is a computer system 100 for generating valuation data of a private company, in accordance with an embodiment. Computer system 100 implements method 5000. Computer system 100 may be computer device 12, 14, 16, 18, 22 of FIG. 1 or computer device 1000 of FIG. 2. Computer system 100 includes processor 102 and memory 104. Processor 102 may be processor 1020 of computer device 1000. Memory 104 may be flash memory 1100 of computer device 1000. Processor 102 executes the steps (or modules) of method 5000. Memory 104 stores the data received, used, and generated by method 5000. Processor 102 interacts with data stored in memory 104 to execute the steps of method 5000. Only one such interaction is shown in FIG. 7 for the reader's ease of reference. However, it will be appreciated that each step of method 5000 may be implemented on computer system 100, notwithstanding that specific interactions of processor 102 and memory 104 are not shown in FIG. 7.

Referring again to FIG. 6, each step of method 5000 will now be explained in detail. At a data merger, Merging Module 5002, company data 5109 is received. Company data 5109 includes Public Company Financial Data 5102, Private Company Financial Data 5104, Public Company Valuation Data 5106, and Private Company Valuation Data 5108. Company data 5109 includes a plurality of financial metrics (not shown).

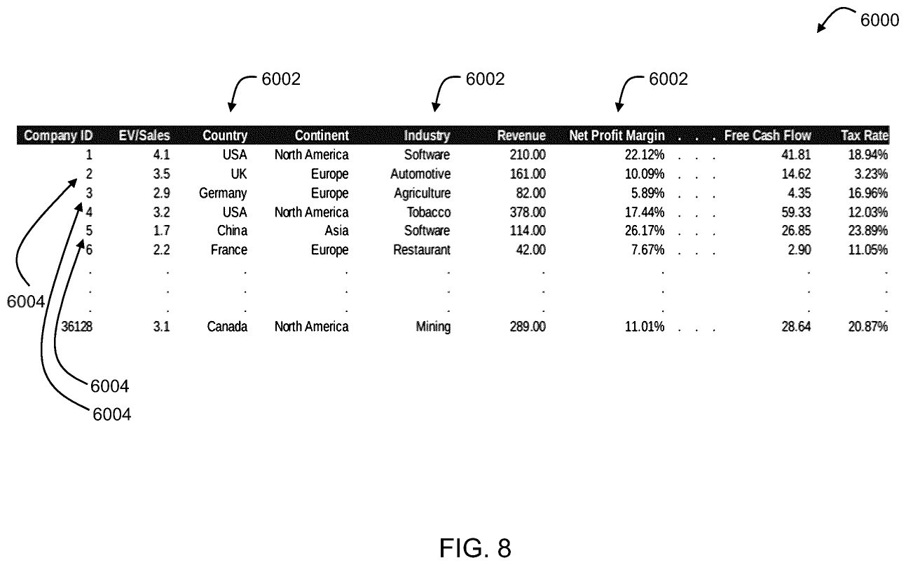

Referring now to FIG. 8, shown therein is a diagram of company data 6000, in accordance with an embodiment. Company data 6000 includes a plurality of company metrics 6002, for a plurality of companies 6004. The plurality of companies 6004 includes public or private companies. The plurality of company metrics 6002 may include financial metrics or valuation metrics. The plurality of company metrics 6002 may include financial fundamentals or qualitative factors. The plurality of company metrics 6002 may also include sub-metrics (i.e., metrics that are associated with other metrics or that other metrics may depend on). It will be appreciated that the plurality of company metrics 6002 may include any metric that may be related to generating valuation data.

For example, financial metrics may include: Revenue, Cost of Goods Sold, Operating Expenses, Operating Income (also known as Earnings Before Interest and Tax), Depreciation and Amortization (often given together), Earnings Before Interest Tax Depreciation and Amortization (EBITDA), Interest Expenses, Earnings Before Tax, Tax Expenses, Net Income, Current Assets, Non-current Assets, Current Liabilities, Non-current Liabilities, Book Value of Debt, Shareholders' Equity, Book Value of Equity, Industry (or Industries), Revenue Split by Industry, Geography (or geographies) operated in, Revenue Split by Geography, Company Type (Public or Private), Exchange (or exchanges) traded on (if applicable), or Stock Ticker (if applicable). Sub-metrics may include: Current Assets, Accounts Receivable, Inventory, or Cash and Cash Equivalents. Valuation metrics may include: Enterprise Value, Firm Value, Market Value of Equity (known as Market Capitalization for public companies), Enterprise Value to Revenue ratio, Enterprise Value to EBITDA ratio, Enterprise Value to Operating Income ratio, Enterprise Value to Book Value of Capital Invested, Price to Revenue ratio, Price to Net Income ratio, or Price to Book Value of Equity ratio.

The plurality of company metrics 6002 may be for a single point in history, or a number of points in history. The historical points may be once a year or multiple times a year. The plurality of company metrics 6002 may include mathematical vectors, which evolve over time. Each coordinate of the vector corresponds to a company metric.

Company data 6000 may be received in a variety of formats. Company data 6000 is shown in FIG. 8 formatted as a table. However, it will be appreciated company data 6000 may be received in any format. In some embodiments, company data 6000 is received in a raw format. In some embodiments, the company data is received as a database file.

Referring again to FIG. 6, company data 5109 is received from different sources. That is, each of Public Company Financial Data 5102, Private Company Financial Data 5104, Public Company Valuation Data 5106, and Private Company Valuation Data 5108 is received from a different source. Each of the different sources may be internal or external. However, in some embodiments, company data 5109 is received from a single source.

Merging Module 5002, merges the received company data 5109 into Merged Data 5110. In some embodiments, the company data 5109 is merged to convert company data 5109 into a single format. In some embodiments, company data 5109 is not merged because it is received in a single format or received from a single source. In such embodiments, merged data 5110 is the same as company data 5109.

Merging Module 5002 transmits merged data 5110 to Train-Test-Calibration Split Module 5004.

Referring again to FIG. 7, Merging Module 5002 is executed on processor 102 of computer system 100. Merging module 5002 receives company data 5109 (e.g., Public Company Financial Data 5102, Private Company Financial Data 5104, Public Company Valuation Data 5106, and Private Company Valuation Data 5108) and stores company data 5109 in memory 104. Merging module 5002 then merges company data 5109 into Merged Data 5110 and stores Merged Data 5110 on memory 104.

Referring again to FIG. 6, at a data splitter, Train-Test-Calibration Split Module 5004, merged data 5110 is apportioned into training data, Train Data 5111; calibration data, Calibration Data 5112; and testing data, Test Data 5113. The amount of data apportioned to each set of data may vary. In some embodiments, the apportionment is 70% training data, 10% calibration data and 20% testing data. As will become apparent, Train Data 5111 is used for training a machine learning model; Calibration Data 5112 is used for calibrating confidence parameters of the machine learning model; and Test Data 5113 is used for testing the machine learning model.

Train-Test-Calibration Split Module 5004 then sends Train Data 511 to Training Preprocessing Module 5006, Calibration Data 5112 to Calibration Preprocessing Module 5008, and Test Data 5113 to Testing Preprocessing Module.

Referring again to FIG. 7, Train-Test-Calibration Split Module 5004 is executed by processor 102 of computer system 100. Processor 102 retrieves Merged Data 5110 from memory 104 and apportions Merged Data 5110 into Train Data 5111, Calibration Data 5112, and Test Data 5113. Processor 102 stores Train Data 5111, Calibration Data 5112, and Test Data 5113 in memory 104.

Referring again to FIG. 6, at a data pre-processor, Training Preprocessing Module 5006, Train Data 5111 is processed into Preprocessed Train Data 5116. Train Data 5111 is processed so that can be more easily used in subsequent steps. Train Data 5111 may be processed using a variety of techniques.

In some embodiments, Training Preprocessing Module 5006 determines whether Train Data 5111 includes missing data. For example, Train Data 5111 may include missing or unknown company metrics for particular companies. Training Preprocessing Module 5006 generates replacement data to replace the missing data. In one embodiment, Training Preprocessing Module 5006 replaces the missing data using the mean or median value for a company metric. In an embodiment, Training Preprocessing Module 5006 fills in the missing data using the mean or median value for a subset of a company metric. For example, the mean or median of a company metric may be calculated for companies located in a particular geography or belonging to a particular industry. In an embodiment, Training Preprocessing Module 5006 generates the missing data using a machine learning or deep learning algorithm, such as a Generative Adversarial Neural Network.

In some embodiments, Training Preprocessing Module 5006 normalizes Train Data 5111. Train Data 5111 is normalized such that the each company metric is within a standard range. Train Data 5111 may be normalized in a variety of ways. In some embodiments, Train Data 5111 is normalized based on a statistical property of a company metric. In some embodiments, Train Data 5111 is normalized by subtracting the mean of a company metric and dividing by the standard deviation of the company metric. In an embodiment, Train Data 5111 is be normalized by applying a logarithmic transform.

Training Preprocessing Module 5006 then sends Preprocessed Train Data 5116 to Feature-Target-Split Module 5012. Training Preprocessing Module 5116 also sends Training Preprocessing Parameters 5114 to Calibration Preprocessing Module 5008, Testing Preprocessing Module 5010, and Preprocessing Module 5022. Training Preprocessing Parameters 5114 include information detailing the methods used to process Train Data 5111.

At a data pre-processor, Calibration Preprocessing Module 5008, Calibration Data 5112 is processed into Preprocessed Calibration Data 5118. Calibration Data 5112 is processed in the same fashion as Train Data 5111, based on Training Preprocessing Parameters 5114. Calibration Preprocessing Module 5008 sends Preprocessed Calibration Data 5118 to Feature-Target-Split Module 5012.

Similarly, at a data pre-processor, Testing Preprocessing Module 5010, Test Data 5113 is processed into Preprocessed Test Data 5120. Test Data 5113 is processed in the same fashion as Train Data 5111 and Calibration Data 5112, based on Training Preprocessing Parameters 5114. Testing Preprocessing Module 5010 sends Preprocessed Test Data 5120 to Feature-Target-Split Module 5012.

In an embodiment, the Calibration Data, Testing Data, and User Data may be pre-processed using different parameters. This may lead to suboptimal results but may be sufficient. For example, the method may use the mean/standard deviation of the Testing Data to normalize the Testing Data, while this may be incorrect, it may not cause any serious issues as the mean/standard deviation of the Testing Data is likely to be close to the mean/standard deviation of the Training Data.

In an embodiment, the method may include certain outliers in the Training Data. For example, the method may include outliers in the Training Data so that the system is aware that such outliers can exist. The method may exclude outliers from the Calibration/Testing Data, to determine how the method performs on normal points.

Referring again to FIG. 7, Training, Calibration, and Testing Preprocessing Modules 5006, 5008, 5010 are executed on processor 102 of computer system 100. Processor 102 retrieves Train Data 5111 from memory 104, processes Train Data 5111 into Preprocessed Train Data 5116, and stores Preprocessed Train Data 5116 and Training Preprocessing Parameters 5114 in memory 104. Processor 102 then retrieves Calibration and Test Data 5112, 5113 and Training Preprocessing Parameters 5114 from memory 104 and processes them into Preprocessed Calibration and Test Data 5118, 5120 based on Training Preprocessing Parameters 5114. Preprocessed Calibration and Test Data 5118 and 5120 are then stored in memory 104.

Referring again to FIG. 6, at Feature-Target-Split Module 5012, Preprocessed Train, Calibration, and Test Data 5116, 5118, 5120 are each split into two data sets. The two data sets may be referred to as independent variables and dependent variables. The independent variables may be referred to as a feature set. The independent variables may contain only financial data. The dependent variables may be referred to as the target set. The dependent variables may contain only valuation data. Preprocessed Train Data 5116 is split into X Train 5122 and Y Train 5124; Preprocessed Calibration Data 5118 is split into X Calibration 5126 and Y Calibration 5128; and Preprocessed Test Data 5120 is split into X Test 5130 and Y Test 5132.

The Feature-Target-Split Module 5012 then passes X Train 5122 and Y Train 5124 to Machine Learning Training Module 5014, X Calibration 5126 and Y Calibration 5128 to Confidence Calibration Module 5016, and X Test 5130 and Y Test 5132 to Testing Module 5018.

Referring again to FIG. 7, Feature-Target-Split Module 5012 is executed by processor 102 of computer system 100. Processor 102 retrieves Preprocessed Train, Calibration, and Test Data 5116, 5118, 5120 from memory 104 and splits them into X and Y Train, Calibration, and Test 5122, 5124, 5126, 5128, 5130, 5132 respectively. Processor 102 then stores X and Y Train, Calibration, and Test 5122, 5124, 5126, 5128, 5130, 5132 in memory 104.

Referring again to FIG. 6, at a model trainer, Machine Learning Training Module 5014, machine learning model, Trained Machine Learning Model 5136 is generated based on X Train 5122 and Y Train 5124. Trained Machine Learning Model 5136 model generally predicts relationships between various company metrics.

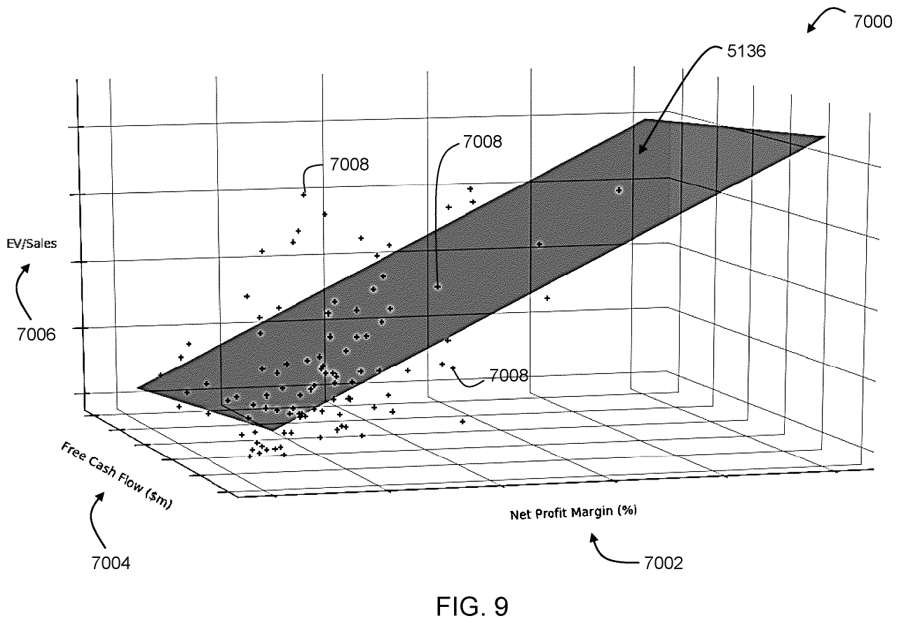

Reference is now made to FIG. 9, shown therein is graph 7000 created from method 5000. Graph 7000 includes Trained Machine Learning Model 5136. Trained Machine Learning Model 5136 includes a plurality of variables: Net Profit Margin 7002, Free Cash Flow 7004, and EV/Sales 7006. Each of variables 7002, 7004, 7006 correspond to a company metric. Trained Machine Learning Model 5136 predicts a relationship between the variables. Although Trained Machine Learning Model 5136 only includes three variables, it will be appreciated that a machine learning model may include more than three variables and may include any number of variables.

Trained Machine Learning Model 5136 may be generated through an iterative process known as training. The machine learning model 5136 includes training parameters to determine how to estimate a target variable for previously unseen data points. The training parameters are internal to the machine learning model 5136. The training parameters have values that may be estimated from the training data. Before training begins, the training parameters may be set to a set of initial training parameter values. The initial training parameter values include predetermined values or random values.

Trained Machine Learning Model 5136 is trained by first generating a preliminary model with the initial training parameter values. During training, the preliminary model is provided either an individual example or a set of examples from X Train. The preliminary model attempts to estimate the correct value of the target variable for the given example or examples. This estimate(s) is compared in some way to the correct value(s) for that example(s) which is stored in Y Train. The parameters are updated to attempt to improve a measure of accuracy on the training set as a whole. This process can be repeated over a number of iterations. On the last iteration, the preliminary model becomes the Trained Machine Learning Model 5136.

In an embodiment, the training process is specific to the type of learning algorithm used to generate the Trained Machine Learning Model 5136. The learning algorithm is selected from a group of suitable techniques, for example, including a multi-variate linear regression algorithm and or a multi-variate non-linear regression algorithm.

In a single-target linear regression, the task T is to predict some value y (often referred to as the target or dependent variable) by outputting:

y*=w·x,

where w is a vector of weights, ·is the dot product (or scalar product) and x is a vector of features (or independent variables). A measure of accuracy may be the mean squared error between the vector of all targets in the test set y_test and their predictions by the eventual model y_(test_predict). Since this measure is not optimized directly, the system instead optimizes the mean squared error between the vector of all targets in the train set y_train and their predictions by the model y_(train_predict). This optimization problem can be written as a matrix equation and therefore can be solved by using an algorithm from linear algebra.

In training a neural network, a similar measure for accuracy may be used (and often referred to as a “loss” or “cost” function). As in single-target linear regression, the task of training the neural network is to minimize the loss function on the training set with the intention that this will minimize the loss function on the testing set. Unlike in single-target linear regression, this optimization may not be done all at once by solving a matrix equation.

In an embodiment, (mini-)batch gradient descent may be used to train the neural network. The neural network includes a number of weights and biases (these are some of the model parameters). The model is given a “batch” (or “mini-batch”) of examples from the training set. The model updates the weights and biases with the aim of reducing the loss function on the training set.

The relationship between the feature values for examples in the batch, the prediction the model makes based on these and the true value of the target variable for examples in the batch are used to update the parameters of the network via a backpropagation process. The backpropagation process may be performed a plurality of times. Reducing the loss function on the training set may reduce the loss function on the test set.

It will be appreciated that Trained Machine Learning Model 5136 may be trained using any suitable technique. In some embodiments, training includes optimizing a loss function. In some embodiments, training includes parameter optimizing, such as grid search, random search, or Bayesian optimization. In some embodiments, training includes a Long Short-Term Memory (LSTM) Recurrent Neural Network (RNN). In some embodiments, training includes a Multilayer Perceptron Feedforward Neural Network, a Support Vector Machine Regressor, a Random Forest Regressor, a Gradient Boosted Regressor, a Kernel Ridge Regressor, or Multivariate Adaptive Regression Splines. It will be appreciated that the machine learning model may be trained using any suitable technique.

In some embodiments, training includes optimizing for the prediction of a single variable. In other embodiments, training includes multi-target learning (i.e., optimizing for the prediction of more than one variable).

Referring again to FIG. 6, Machine Learning Training Module 5014 then passes Trained Machine Learning Model 5136 to Confidence Calibration Module 5016, Testing Module 5018, and Machine Learning Prediction Module 5024.

Referring again to FIG. 7, Machine Learning Training Module 5014 is executed by processor 102 of computer system 100. Processor 102 retrieves X Train 5122 and Y Train 5124 from memory 104, generates Trained Machine Learning Model 5136, and stores Trained Machine Learning Model 5136 in memory 104.

Referring again to FIG. 6, at a confidence calibrator, Confidence Calibration Module 5016, a confidence score, Confidence Parameter 5134, is generated. Confidence Parameter 5134 is generated based on Trained Machine Learning Model 5136, X Calibration 5126, and Y Calibration 5128. Confidence Parameter 5134 includes a confidence range and a confidence level. Confidence Parameter 5134 describes a confidence range within which a particular variable may be predicted, within a particular confidence level (e.g., a statistical level of confidence, such as 90% or 95%).

Confidence Parameter 5134 is generated by determining a strangeness score for X Calibration 5126, Y Calibration 5128, and data predicted by Trained Machine Learning Model 5136. The strangeness scores are compared to determine Confidence Parameter 5134. A strangeness score is a measure of how strange a company (as a whole) is relative to other companies in the same data set. That is, the strangeness score may be considered a measure of conformity.

In one embodiment, each company in X Calibration 5126 is given a score based on how strange the company is relative to the other points in X Calibration 5126. In such an embodiment, the strangeness score is defined by:

$${α}_{i} = \frac{\vert {y}_{i} - {\hat{y}}_{ι} \vert}{exp ( {γλ}_{i}^{k} ) + exp ( {ρξ}_{i}^{k} )}$$

where yᵢ is the true prediction of the point in X Calibration 5126 and ŷᵢ is the prediction given by the Trained Machine Learning Model 5136. γ and ρ are both sensitivity parameters that take values between 0 and 1. The λ and ξ parameters are defined by:

$${λ}_{i}^{k} = \frac{{d}_{i}^{k}}{median ( \{ {d}_{j}^{k} : {z}_{j} ∈ {T}_{i} \} )}$$

$$and$$

$${ξ}_{i}^{k} = \frac{{s}_{i}^{k}}{median ( \{ {s}_{j}^{k} : {z}_{j} ∈ {T}_{i} \} )}$$

With Tᵢ being X Train 5122, d being defined as the sum of the distances from the point in question to its k nearest neighbors in some space by:

$${d}_{i}^{k} = {\sum }_{j = 1}^{k} distance ( {x}_{i} , {x}_{{i}_{j}} )$$

and s being defined by

$${s}_{i}^{k} = \sqrt{\frac{1}{k} {\sum }_{j = 1}^{k} {( {y}_{{i}_{j}} - \overline{{y}_{{ι}_{1 , … , k}}} )}^{2}}$$

$$where$$

$$\overline{{y}_{{ι}_{1 , … , k}}} = \frac{1}{k} {\sum }_{j = 1}^{k} {y}_{{i}_{j}}$$

These scores are then sorted from lowest to highest in a list. Based on a predefined level of confidence required (90% in some embodiments), one of these scores is chosen. For all subsequent predictions given by the machine learning model, the confidence region is given by

(ŷ_{l+g}−α₍ₘ₊ₛ₎(exp(γλᵢ^{k})+exp(ρξᵢ^{k})), y_{l+g}+α₍ₘ₊ₛ₎(exp(γλᵢ^{k})+exp(ρξᵢ^{k})))

where αₘ₊ₛ is the Chosen Score. γ, ρ and the Chosen Score are included in Confidence Parameter 5134.

Confidence Calibration Module 5134 then passes Confidence Parameter 5134 to Testing Module 5018 and Machine Learning Prediction Module 5024.

At a model tester, Testing Module 5018, model testing data is generated. The model testing data is generated based on Trained Machine Learning Model 5136, X Test 5130, and Y Test 5132. The model testing data is used to evaluate how the Trained Machine Learning Model 5136 can perform on previously unseen data. Testing Module 5018 uses Trained Machine Learning Model 5136 and X Test 5130 to generate Y Test predictions. Y Test predictions are then compared to Y Test 5132.

The model testing data is further used to evaluate Confidence Parameter 5134. That is, model testing data is evaluated to determine whether it falls within the particular confidence range and confidence level of Confidence Parameter 5134. For example, the Y Test predictions may be compared to Y Test 5132 to determine the percentage of Y Test predictions that fall within the confidence range of Confidence Parameter 5134. This percentage may be compared to the confidence level of Confidence Parameter 5134. If the percentage of predictions falling within the confidence range is approximately the confidence level, the Confidence Parameter 5134 is considered robust.

It will be understood by those familiar with the art that there are a number of ways to generate confidence ranges. For example, this could be achieved if the Trained Machine Learning Model 5136 is generated using a Bayesian Neural Network. In other embodiments, dropout can be used as a Bayesian approximation, this also allows for the generation of confidence ranges.

In some embodiments, a further machine learning model is generated at Machine Learning Training Model 5014. The further machine learning model may be generated based on the model testing data and Trained Machine Learning Mode 5136. In some embodiments, the further machine learning model is generated based on all training sets and all testing sets (e.g., X and Y Train, Calibration, and Test 5122, 5124, 5126, 5128, 5130, 5132).

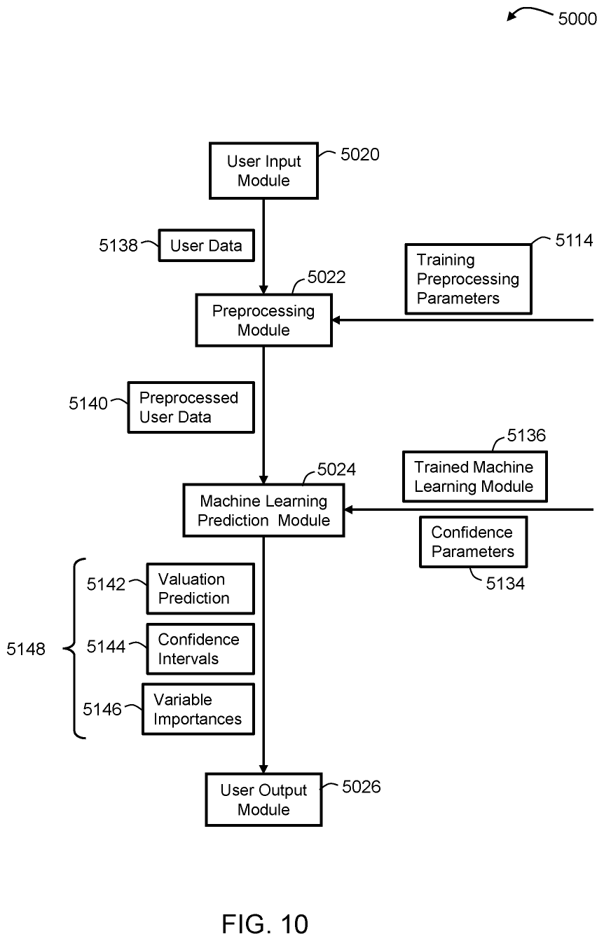

Referring now to FIG. 10, shown therein is a continuation of method 5000. At a user input receiver, User Input Module 5020, a request to generate valuation data, User Data 5138 is received. User Data 5138 includes private company data. The private company data includes at least one financial metric of the private company. For example, User Data 5138 may be sent by a user seeking to valuate a private company. The user may submit various financial metrics of the target private company with his or her request. At least one financial metric corresponds to at least one variable of the Trained Machine Learning Model 5136. For example, a user may submit the industry of a private company. Trained Machine Learning Model 5136 may correspondingly include industry as a variable. In some embodiments, the private company data includes financial metrics but not valuation metrics.

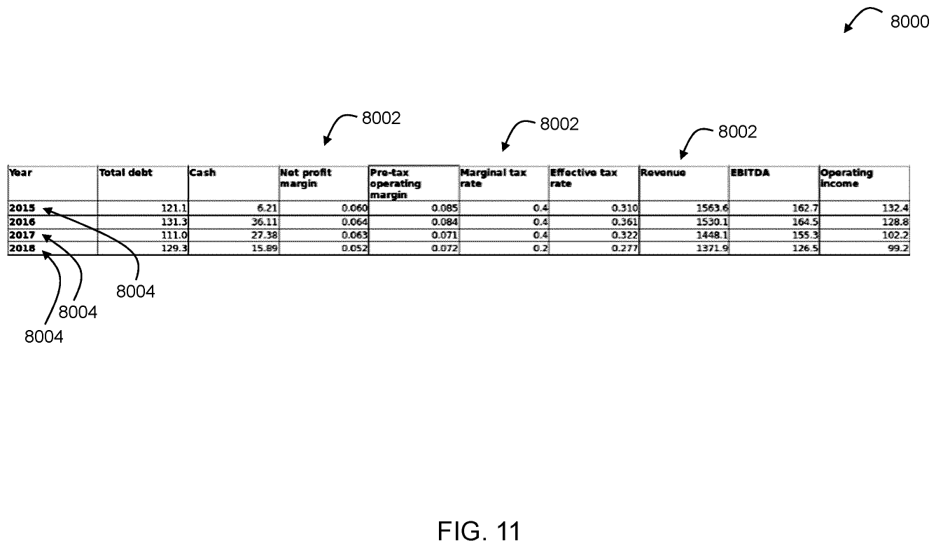

User Data 5138 may be received in various formats. Referring now FIG. 11, shown therein is a diagram of private company data 8000. Private company data 8000 includes a plurality of financial metrics 8002 and a plurality of time periods 8004. It will be appreciated that although only some financial metrics and time periods are illustrated in FIG. 11, a user may include any number of financial metrics or time periods. It will also be appreciated that although private company data is shown as a table in FIG. 11, the private company data may be received as any format.

Referring again to FIG. 10, User Input Module 5020 sends User Data 5138 to Preprocessing Module 5022.

Referring again to FIG. 7, User Input Module 5020 is executed by processor 102 of computer system 100. Processor 102 receives User Data 5138 and stores User Data 5138 in memory 104.

Referring again to FIG. 10, at Preprocessing Module 5022, User Data 5138 is normalized. User Data 5138 is processed (e.g., normalized) in the same fashion as Train Data 5111, based on Training Preprocessing Parameters 5114, to generate Preprocessed User Data 5140. Preprocessing Module 5022 then sends Preprocessed User Data 5140 to Machine Learning Prediction Module 5024.

Referring again to FIG. 7, Preprocessing Module 5022 is executed by processor 102 of computer system 100. Processor 102 retrieves User Data 5138 and Training Preprocessing Parameters 5114 from memory 104. Processor 102 processes User Data 5138 based on Training Preprocessing Parameters 5114 to generate Preprocessed User Data 5140. Processor 102 then stores Preprocessed User Data 5140 in memory 104.

Referring again to FIG. 10, at a model predictor, Machine Learning Prediction Module 5024, valuation data 5148 is generated, based on Trained Machine Learning Model 5136 and Preprocessed User Data 5140.

Valuation data 5148 includes Valuation Prediction 5142. Valuation Prediction 5142 includes valuation metrics of a target private company. For example User Data 5138 may include financial metrics Free Cash Flow and Net Profit Margin of a target private company. Referring again to FIG. 9, Free Cash Flow and Net Profit Margin correspond to variables 7004 and 7002 of Trained Machine Learning Model 5136. Based on these financial metrics, Machine Learning Prediction Module 5024 may use Trained Machine Learning Model 5136 to predict EV/Sales of the target company. It will be appreciated that only three variables and two financial metrics are used in the above example for ease of explanation. In other embodiments, any number of variables and company, valuation, or financial metrics may be used.

Referring again to FIG. 10, valuation data 5148 includes company metric importance data, Variable Importances 5146. Variable Importances 5146 quantifies the impact of a company metric on Valuation Prediction 5142. That is, Variable Importances 5146 corresponds to the relative effect of a company metric on the predictions of Trained Machine Learning Model 5136. Variable Importances 5146 may be assessed for an individual company, a subset of companies, or for every company in the company data.

Variable Importances 5146 may be generated by a variety of techniques. In some embodiments, the company metric importance data is generated using SHAP (SHapley Additive exPlanations) or LIME (Local Interpretable Model-agnostic Explanations) techniques. In some embodiments, the Preprocessed User Data 5140 is locally perturbed a number of times. That is, some company metrics are increased or decreased slightly in value. In some embodiments, the Preprocessed User Data 5140 may be perturbed hundreds or thousands of times. The perturbed data is then passed through Trained Machine Learning Model 5136 and its predictions are recorded. These predictions may be then used to evaluate the effect of various company metrics on the predictions of Trained Machine Learning Model 5136. In some embodiments, the perturbed points are then treated as the features and their predictions are used as the targets for a new data set on which a tree based machine learning model (e.g., a gradient boosted decision tree model) may be trained.

In some embodiments, valuation data 5148 includes comparable company data. Comparable company data includes companies that are similar or comparable to a target private company. In some embodiments, company similarity is determined based on the closeness of data points in the Trained Machine Learning Model 5136.

Referring again to FIG. 9, graph 7000 includes data points 7008. Data points 7008 which are located at similar positions within graph 7000 may be considered to be comparable. In some embodiments, representation of the feature space in a layer of a neural network is used as an approximation for a company similarity. The comparable companies returned are those which are the closest to the target company in terms of the Euclidean (or some other) distance metric in a geometric representation of the chosen layer. Each layer can be represented as a geometric space and the system observes the nearest neighbors in any given layer as being “similar” in some way. In another embodiment, company similarity may be determined using closest data points in the original feature space.

Referring again to FIG. 10, the valuation data includes confidence data, Confidence Intervals 5144. Confidence Intervals 5144 includes Confidence Parameters 5134.

Machine Learning Prediction Module 5024 then passes the valuation data 5148 to User Output Module 5026.

Referring again to FIG. 7, Machine Learning Prediction Module 5024 is executed by processor 102 of computer system 100. Processor 102 retrieves Trained Machine Learning Model 5136 and Confidence Parameter 5134 from memory 104. Processor 102 then generates valuation data 5148 (i.e., Valuation Prediction 5142, Variable Importances 5146, and Confidence Intervals 5144) and stores valuation data 5148 in memory 104.

Referring again to FIG. 10, at User Output Module 5026, valuation data 5148 is transmitted. For example, valuation data 5148 may be transmitted to a user device, such as devices 12, 14, 16, 18, 22 of FIG. 1 or device 1000 of FIG. 2. The valuation data may be transmitted in various formats. In some embodiments, the valuation data is transmitted in a format compatible with being displayed on a graphical user interface. In other embodiments, the valuation data is transmitted in a table or spreadsheet format. In some embodiments, the valuation data is transmitted in a database format. In some embodiments, the valuation data is transmitted in a raw format. In some embodiments, the valuation data is collated into a report and transmitted as a report.

At User Output Module 5026, valuation data 5148 is also displayed. For example, the valuation data may be displayed on a user device, such as devices 12, 14, 16, 18, 22 of FIG. 1 or device 1000 of FIG. 2. The valuation data 5148 may be displayed in a variety of ways. In some embodiments, only a subset of the valuation data 5148 is displayed. In some embodiments, the valuation data 5148 is displayed on a graphical user interface. Using the graphical user interface, a user is able to interact with the valuation data 5148. In other embodiments, the valuation data 5148 is displayed as graphic objects with no user interactivity.

Valuation data 5148 may be displayed in various formats. For example, valuation data 5148 may be displayed as numbers. In some embodiments, the valuation data is displayed as a graphic. In some embodiments the graphic is static (i.e., an image). For example, the valuation data 5148 is displayed as a graph, such as a bar graph or line chart. The valuation data 5148 may also be displayed in a table format. In other embodiments, the valuation data is displayed dynamically. That is, the valuation data 5148 displayed may change over time. For example, the valuation data may be displayed as an animated graphic.

Referring again to FIG. 7, User Output Module 5026 is executed by processor 102 of computer system 100. Processor 102 retrieves valuation data 5148 (e.g., Valuation Prediction 5142, Confidence Intervals 5144, and Variable Importances 5146) from memory 104 and transmits and displays valuation data 5148.

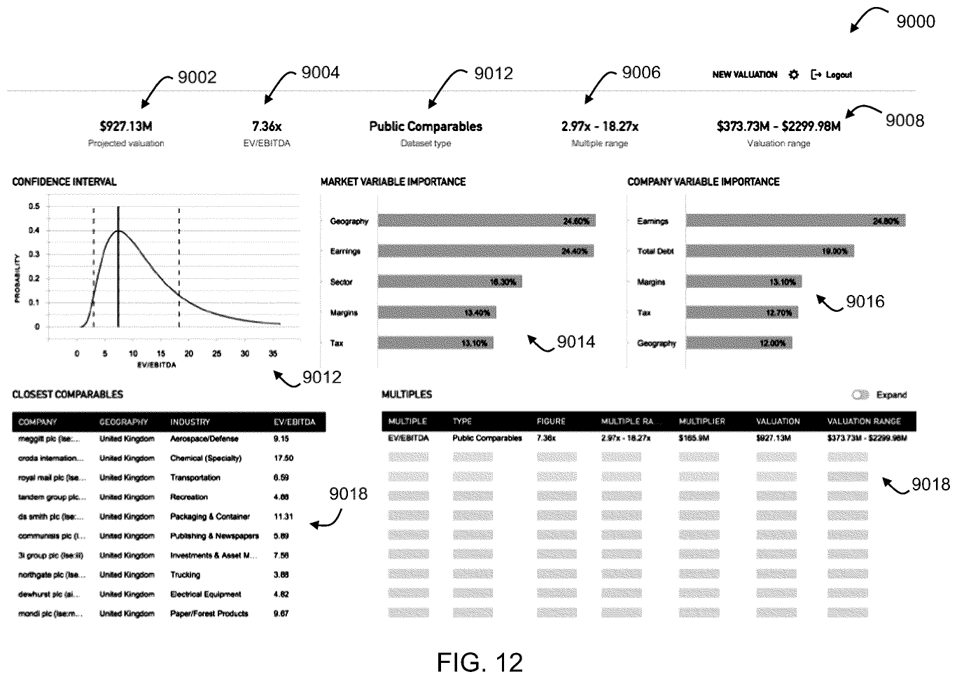

Reference is now made to FIG. 12, therein shown is a user interface 9000 displaying valuation data. User interface 9000 displays various components of the valuation data 5148, such as Valuation Prediction 5148. Text 9002 shows Projected valuation and text 9004 shows EV/EBITDA. User interface 9000 also displays Confidence Intervals 5114. Text 9006 and text 9008 show confidence intervals for the Projected valuation and for the EV/EBITDA respectively. User Interface 9000 also displays Valuation Prediction 5148 and Confidence Intervals 5114 as a graphic. Line graph 9010 shows the predicted EV/EBITDA and confidence interval for the prediction. User interface 9000 also displays Variable Importances 5146. Bar graph 9014 and bar graph 9016 show the relative importance of company metrics for the market and the target company respectively. Comparable company data is also displayed. Table 9018 shows a list of companies which are closest in similarity to the target company.

The user interface 9000 also includes other text and graphic elements which provide the user with additional information. Text 9012 informs the user that the dataset used in the machine learning model to generate the valuation data was Public Comparables. The user interface 9000 also includes text and graphic elements that the user may interact with. Interactive table 9020 allows a user to select a company metric to view. Although only one company metric is displayed in user interface 9000, it will be appreciated that any number of company metrics may be displayed. Moreover, it will be appreciated that any valuation data 5148 may be displayed in the user interface.

While the above description provides examples of one or more apparatus, methods, or systems, it will be appreciated that other apparatus, methods, or systems may be within the scope of the claims as interpreted by one of skill in the art.

1. A system for generating valuation data of a private company, the system comprising:
a data merger, the data merger for receiving company data,
the company data including a plurality of company metrics,
wherein at least one company metric of the plurality of company metrics corresponds to a company other than the private company;
a model trainer, the model trainer for generating a machine learning model, based on the company data,
the machine learning model including a plurality of variables, each variable of the plurality of variables corresponding to at least one company metric of the plurality of company metrics;
a user input receiver, the user input receiver for receiving a request to generate the valuation data; and
a model predictor, the model predictor for generating the valuation data based on the machine learning model and the request to generate the valuation data.

2. The system of claim 1, wherein the request to generate the valuation data includes private company data,
the private company data including at least one financial metric of the private company,
the at least one financial metric of the private company corresponding to the at least one variable of the plurality of variables.

3. The system of claim 1, further comprising:
a data pre-processor, the data preprocessor for normalizing the company data, based on at least one statistical property of at least one company metric of the plurality of company metrics.

4. The system of claim 1, further comprising:
a data pre-processor, the data pre-processor for:
determining whether the company data includes missing data; and
generating replacement data, whereby the replacement data replaces the missing data.

5. The system of claim 1, further comprising:
a data splitter, the data splitter for apportioning the company data into training data, calibration data, and testing data;
a confidence calibrator, the confidence calibrator for generating a confidence score for at least one company metric of the plurality of company metrics, based on the machine learning model and the calibration data.

6. The system of claim 5, further comprising:
a model tester, the model tester for generating model testing data based on the machine learning model and the testing data.

7. A computer-implemented method for generating valuation data of a private company, the method comprising:
receiving company data,
the company data including a plurality of company metrics,
wherein at least one company metric of the plurality of company metrics corresponds to a company other than the private company;
generating a machine learning model, based on the company data,
the machine learning model including a plurality of variables, each variable of the plurality of variables corresponding to at least one company metric of the plurality of company metrics;
receiving a request to generate the valuation data; and
generating the valuation data, based on the machine learning model and the request to generate the valuation data.

8. The method of claim 7, wherein the valuation data includes variable importances that quantify an impact of the at least one company metric on valuation prediction, and wherein the variable importances correspond to a relative effect of the at least one company metric.

9. The method of claim 7, wherein the request to generate the valuation data includes private company data,
the private company data including at least one financial metric of the private company,
the at least one financial metric of the private company corresponding to the at least one variable of the plurality of variables.

10. The method of claim 7, wherein generating the machine learning model includes optimizing a loss function.

11. The method of claim 7, wherein generating the machine learning model includes multi-target learning.

12. The method of claim 7, further comprising:
normalizing the company data, based on at least one statistical property of at least one company metric of the plurality of company metrics.

13. The method of claim 7, further comprising:
determining whether the company data includes missing data; and
generating replacement data, whereby the replacement data replaces the missing data.

14. The method of claim 13, wherein generating replacement data is based on at least one statistical property of at least one company metric of the plurality of company metrics.

15. The method of claim 13, wherein generating replacement data is based on the machine learning model.

16. The method of claim 7, further comprising:
apportioning the company data into training data, calibration data, and testing data; and
generating a confidence score for at least one company metric of the plurality of company metrics, based on the machine learning model and the calibration data.

17. The method of claim 7, further comprising:
generating model testing data based on the machine learning model and the testing data.

18. The method of claim 17, further comprising:
generating a further machine learning model, based on the model testing data, and the machine learning model.

19. The method of claim 7, wherein the valuation data includes comparable company data and company metric importance data.

20. A non-transitory computer-readable medium storing instructions executable on a processor for implementing a method for generating valuation data of a private company, the method comprising:
receiving company data,
the company data including a plurality of company metrics,
wherein at least one company metric of the plurality of company metrics corresponds to a company other than the private company;
generating a machine learning model, based on the company data,
the machine learning model including a plurality of variables, each variable of the plurality of variables corresponding to at least one company metric of the plurality of company metrics;
receiving a request to generate the valuation data; and
generating the valuation data, based on the machine learning model and the request to generate the valuation data.
